(19) United States
(12) Patent Application Publication
(10) Pub. No.: US 2009/0309886 A1
(43) Pub. Date: Dec. 17, 2009

(54) INTELLIGENT EXTERNAL DISPLAY CONFIGURATION ON MOBILE DEVICES

(75) Inventor: Brandon Sneed, San Francisco, CA (US)

Correspondence Address: Trellis Intellectual Property Law Group, PC, 1900 EMBARCADERO ROAD, SUITE 109, PALO ALTO, CA, 94303, US

(73) Assignee: OQO, Inc., San Francisco, CA (US)

(21) Appl. No.: 12/139,322

(22) Filed: Jun. 13, 2008

(51) Int. Cl. G06F 13/14

(52) U.S. Cl. 345/520

(57) ABSTRACT

An external display configuration approach is disclosed. In one embodiment, a method can include: using an interface of a portable computing device to define preferred settings, where the preferred settings designate preferences for a display that is external to the portable computing device; detecting in the portable computing device, a connection of an external display to the portable computing device; loading the preferred settings when capabilities of the external display support the preferred settings; and adjusting settings of the external display to match the preferred settings.

### FIELD OF THE INVENTION

The invention relates in general to displays associated with electronic devices, and more specifically to mobile device external display configuration.

### BACKGROUND

Portable computing or electronic devices often house relatively small display screens. Thus, devices, such as phones, personal digital assistants (PDAs), small computers, e-mail devices, audio players, video players, etc., are often coupled to other display devices. For example, a user may choose to connect a portable computing device to a projector for making a presentation.

However, external displays (e.g., projector systems) may not be fully compatible with each such portable computing device. Further, when the external displays are connected, display quality typically sufferers due to initial application of the lowest display device capabilities.

### SUMMARY

An external display configuration approach in accordance with embodiments of the present invention can be utilized to facilitate displaying from a portable computing device. Further, a user's preferred settings can be considered in comparison with specific external display device settings in order to optimize chosen settings for the display. In addition, a matching of the user's preferences can be performed in substantially automated fashion.

In one embodiment, a method can include: using an interface of a portable computing device to define preferred settings, where the preferred settings designate preferences for a display that is external to the portable computing device; detecting in the portable computing device, a connection of an external display to the portable computing device; loading the preferred settings when capabilities of the external display support the preferred settings; and adjusting settings of the external display to match the preferred settings.

### BRIEF DESCRIPTION OF THE DRAWINGS

FIG. 1 illustrates an example portable computing device arrangement in accordance with embodiments of the present invention.

FIG. 2 shows an example external display manager in accordance with embodiments of the present invention.

FIG. 3 shows an example user preference selection interface in accordance with embodiments of the present invention.

FIG. 4 shows example external display setting adjustments in accordance with embodiments of the present invention.

FIG. 5 illustrates a flow diagram of a first example method of configuring an external display in a mobile device in accordance with embodiments of the present invention.

FIG. 6 illustrates a flow diagram of a second example method of configuring an external display in a mobile device in accordance with embodiments of the present invention.

### DETAILED DESCRIPTION

An external display configuration approach in accordance with embodiments of the present invention can be utilized to facilitate displaying from a portable computing device coupled to the external display. Preferred settings defined by a user and stored in the portable computing device can be considered in comparison with specific external display device settings or capabilities in order to optimize chosen settings for the display. In addition, a matching of the user's preferences can be performed in substantially automated fashion.

External displays suitable for use in particular embodiments can include any common display, such as a projector, a cathode ray tube (CRT), liquid crystal display (LCD), plasma display, digital light processor (DLP), or some other display device. Further, a user can define preferred settings for a particular external device type, or for a more general display that is applicable to any such displays. In this approach, each known display need not have specific settings, and each display device need not be used initially at its lowest capabilities.

Particular embodiments can eliminate substantial user interaction that is typically associated with connecting to or disconnecting from external display devices. In such other approaches, a user may be required to navigate into a special user interface in order to set the display's settings, to enable the display, and then to manually confirm as to whether the settings are correct. Such other approaches may also require the user to know particular specifications of a given display device, or to acquire these specifications by trial-and-error techniques, which could potentially cause hardware damage.

In particular embodiments, once a new external display device is found, a mode or setting that best matches the user's preferences may be selected automatically, as opposed to having a relatively interactive and time consuming process. In certain embodiments, a user may not need to specifically reconfigure the mobile or portable computing device for each external display that may be connected. As an example of such specific reconfiguration, some mobile devices (e.g., notebook computers) might store a configuration for each device that is ever connected, and any changes the user makes to that device's resolution, color depth, etc., are only available for that specific device.

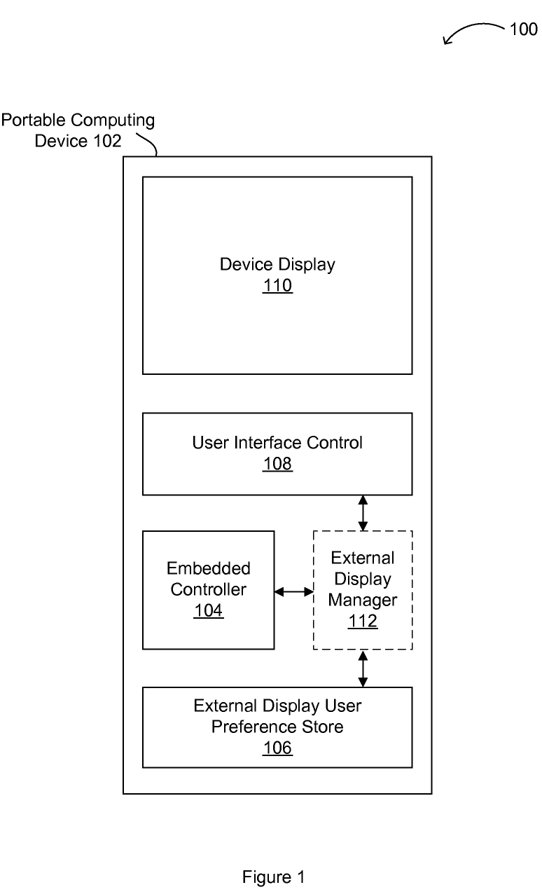

Referring now to FIG. 1, an example portable computing device arrangement in accordance with embodiments of the present invention is indicated by the general reference character 100. Portable computing device 102 can include embedded controller 104, external display user preference store 106, user interface control 108, device display 110, and external display manager 112. Although external display manager 112 is described primarily with respect to an operating software component or module, it can include any hardware, firmware, and/or software components. For example, external display manager 112 may be implemented as firmware within embedded controller 104.

In any event, external display manager 112 may be configured to manage external display detection, switching to a newly connected external display, and user preferences. When a user of a mobile device connects an external display to portable computing device 102, external display manager 112 can automatically detect that an external display is now connected. External display manager 112 may then load a user's preferred settings (e.g., from user preference store 106), and compare the loaded preferences to the external display's capabilities. If a perfect match thereof is not possible, a user's preferred settings may be temporarily adjusted to best match the capabilities of the external display. Once this adjustment is complete, the external display may be turned on and set to those adjusted settings.

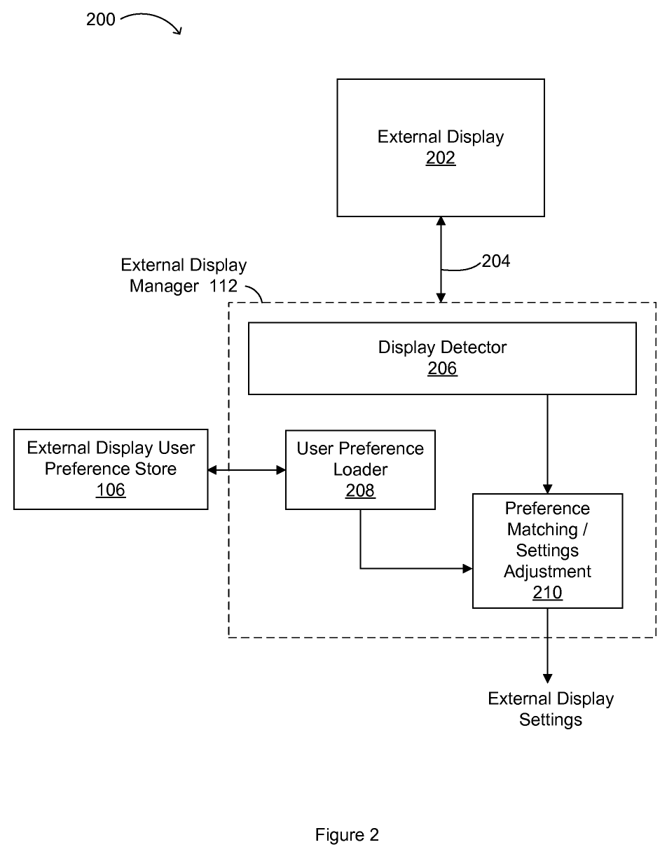

Referring now to FIG. 2, an example external display manager in accordance with embodiments of the present invention is shown and indicated by the general reference character 200. External display 202 may be connected to portable computing device 102 via connection 204 (shown here coupled to external display manager 112). For example, connection 204 can be a video graphics array (VGA) connector, and automated switching to a newly connected external display 202 can be initiated when a pin 14 is high on a standard 15-pin analog VGA connector. Connection 204 may also be at least partially a wireless connection. Capabilities of external display 202 may be queried and passed to a preference matching module 210 in external display manager 112 via connection 204.

User preference loader 208 can retrieve defined user preferences from external display user preference store 106 (e.g., a non-volatile memory, such as electrically erasable programmable read-only memory (EEPROM)). These preferences can then be provided to preference matching and settings adjustment module 210. Display detector 206 can detect the presence of external display 202, and provide characteristics and/or settings capabilities of external display 202 to preference matching and settings adjustment module 210. In particular embodiments, when external display 202 supports a match of full capabilities based on stored user preferences (e.g., from preference store 106), those user preferences can be supplied as the external display settings (e.g., for display 202). However, temporary adjustments can be made (e.g., in settings adjustment module 210) when external display 202 is not a full match to the preferred user settings.

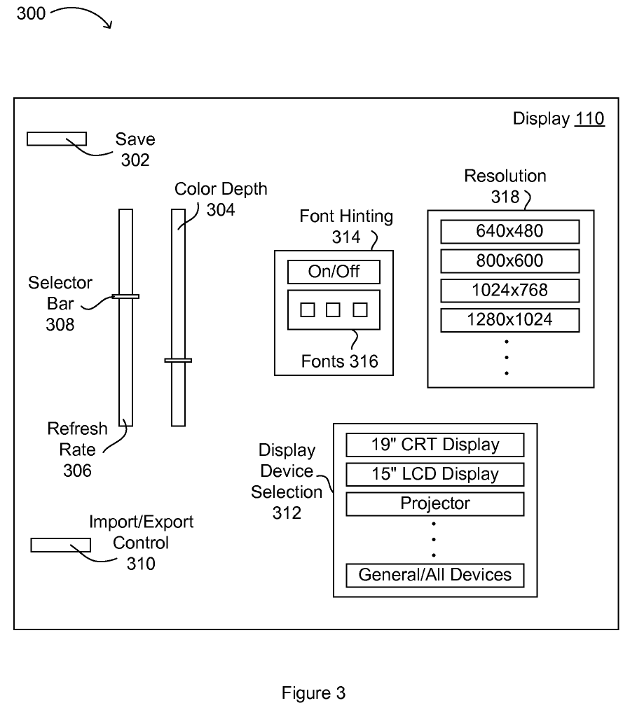

Referring now to FIG. 3, an example user preference selection interface in accordance with embodiments of the present invention is shown and indicated by the general reference character 300. In particular embodiments, a user can define preferred settings that may be used whenever any external display device is connected to the portable computing device. Display 110 (e.g., an internal display on portable computing device 102) can show various options for selection (e.g., via a touchscreen, associated buttons, etc.) by a user. Alternatively, another display or device can be coupled to portable computing device 102 for such preference setting.

Settings for a given external display (e.g., as designated via display device selection 312) can include resolution 318, color depth 304, refresh rate 306, and font hinting 314. Resolution 318 can specify a desired width and height of an external display in pixels. Color depth 304 can define a maximum number of colors to be used in the external display. Refresh rate 306 may designate a frequency (in hertz) at which to use a display. For example, refresh rate 306 and color depth 304 can be chosen using selector bars 308. Font hinting 314 can specify whether font smoothing may be used (e.g., via on/off selection), as well as particular font selections 316 (e.g., Times New Roman, Arial, etc.) in some applications.

In addition, import/export control 310 can be used to pass user preference files from/to another location (e.g., a website, Internet-based storage location, etc.) or device, such as an external storage device or docking station. Further, user preference settings can be stored (e.g., in preference store 106) using save button 302 when the user has completed making the preference choices. Finally, while particular settings may be chosen for a certain selected display device 312, these settings may otherwise be set for any such device (e.g., using display device selection “general/all devices” in selection 312).

Maximum settings may also tend to scale in relation to a viewable size of an external display. For example, an external display, such as a projector, may report that the capabilities of that display only support resolutions of 640×480 or 800×600 due to the display size and type of usage. On the other hand, an LCD or CRT may have maximum resolutions that account for the physical size of the viewable area. For example, capabilities of a 12″ LCD display may support resolutions at or below 1024×768 because anything smaller might be substantially unreadable.

Font hinting 314 may not necessarily represent a particular capability of a display device, but rather may play a relatively large role in readability by the user. For example, some users prefer blocky fonts to smooth fonts, and particularly at smaller sizes for improved clarity. Pixel orientation of a display also plays a role in the readability of fonts on a given display, such as when dealing with LCDs where pixels can be aligned in a red-green-blue (RGB) or blue-green-read (BGR) layout. These, as well as any other suitable preference choices, can also be incorporated in user interface 300.

Particular embodiments can also support preference matching when an external display may not be fully capable of supporting the preferred settings of a user. For such preference matching, various parameters may be temporarily adjusted (e.g., lowered) to accommodate the supported capabilities of a particular external display. For the determination of display capabilities, many modern external display devices (e.g., those targeted toward personal computers and laptops, and made within the last 5-10 years) support a protocol known as display data channel (DDC) that allows retrieval of a table of supported resolutions, color depths, and frequencies. This table may be used to determine a closest match to a user's preferred settings, and a determination can be made as to which preferences can be temporarily adjusted to best meet a user's requirements without exceeding external display capabilities.

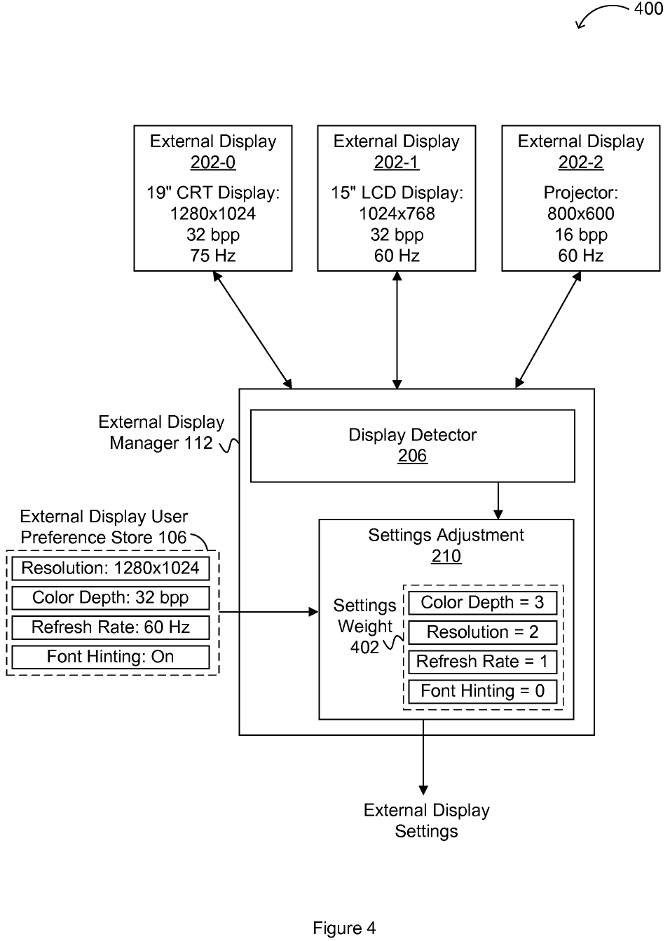

Referring now to FIG. 4, example external display setting adjustments in accordance with embodiments of the present invention are shown and indicated by the general reference character 400. For example, a user may have preferred settings in preference store 106, of resolution: 1280×1024; color depth: 32 bpp; refresh rate: 60 Hz; and font hinting: on. In this example, one of three external displays 202 (e.g., 19″ CRT display 202-0, 15″ LCD display 202-1, and projector 202-2) can be selected for connection to the portable computing device.

Each of these external display devices 202 varies in capabilities, with only the 19″ CRT display 202-0 being able to provide for an exact match to the user's preferred settings loaded from store 106. In particular embodiments, a matching algorithm (e.g., in settings adjustment module 210) can assign a weight (e.g., settings weight 402) to each of the four settings based on the most desirable settings to match. For example, settings weight 402 can include weightings of color depth=3; resolution=2; refresh rate=1; and font hinting=0.

Thus when the portable computing device is connected to the 15″ LCD display 202-1, the portable computing device may compare preferred settings (e.g., from store 106) to the capabilities (e.g., retrieved from external display 202 and display detector 206 using DDC). In this particular example, color depth takes precedence over resolution, so the resolution is temporarily lowered to be 1024×768, representing that capability of 15″ LCD display 202-1. In the case of projector 202-2, neither color depth nor resolution can be fully preserved, thus the color depth may be lowered to a next best supported value, followed by the resolution.

For situations where preferred settings of a user may be temporarily lowered, the lowered values may last only for a duration of use of the specific external display. For example, if a user is connected to projector 202-2, the preferred settings can be lowered to 800×600 at 16 bpp. However, when the user disconnects projector 202-2 from the portable computing device, and then connects to 19″ CRT display 202-0, the 19″ CRT display 202-0 may then be set to 1280×1024 at 32 bpp, thus taking advantage of superior external display capabilities, and in accordance with the user's preferred settings.

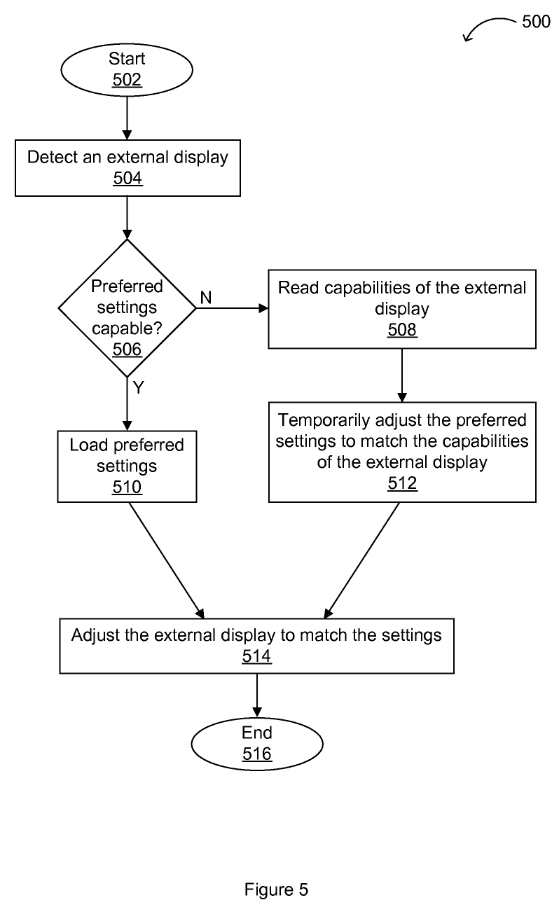

Referring now to FIG. 5, a flow diagram of a first example method of configuring an external display in a mobile device in accordance with embodiments of the present invention is shown and indicated by the general reference character 500. The flow begins 502, and an external display can be detected when connected to a portable computing device (504). If the external display is capable of supporting the preferred settings found in the portable computing device (506), these preferences can be loaded (510). Settings of the external display can then be adjusted to match the loaded preferences (514), completing the flow 516.

However, if the external display is not capable of supporting one or more preferred settings from the portable computing device (506), the capabilities of the external display can be read (508). As discussed, these capabilities can be read using DDC, or any other suitable signal connection and/or protocol between the external display and the portable computing device. The preferred settings can then be temporarily adjusted (e.g., using a weighting in a matching algorithm) to match the external display capabilities (512). Settings of the external display can then be adjusted to match the temporarily adjusted preferred settings (514), thus completing the flow 516.

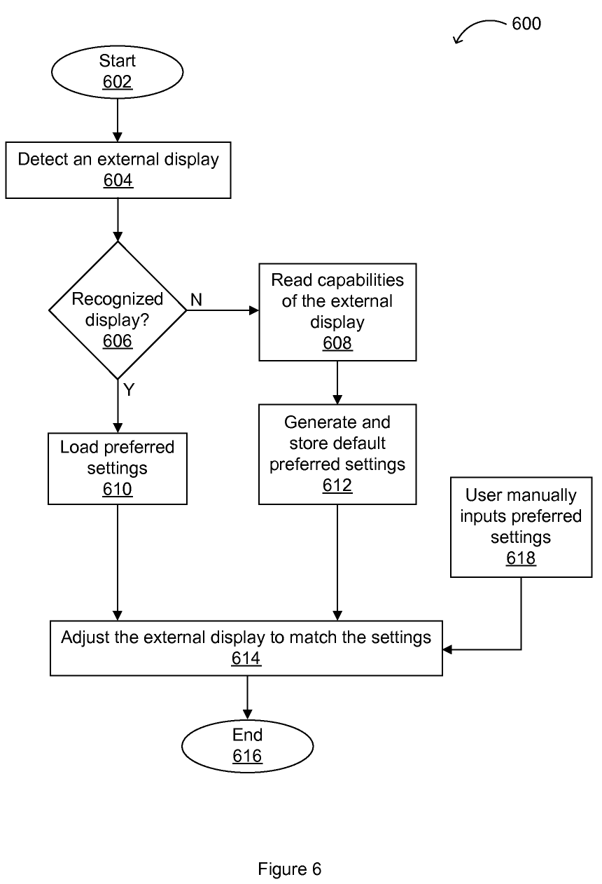

Referring now to FIG. 6, a flow diagram of second example method of configuring an external display in a mobile device in accordance with embodiments of the present invention is shown and indicated by the general reference character 600. The flow begins 602, and an external display can be detected when connected to a portable computing device (604). If the external display is a recognized as a known display, or was previously connected to the portable computing device (606), the user's preferred settings can be loaded (610). Settings of the external display can then be adjusted to match the loaded preferences (614), completing the flow 616. However, if the external display is not a known display or was not previously connected to the portable computing device (606), the capabilities of the external display can be read (608). Default preferred settings can then be generated and stored (612). In any event, a user can manually input preferred settings (618), and settings of the external display can be adjusted accordingly (614), thus completing the flow 616.

Although particular embodiments of the invention have been described, variations of such embodiments are possible and are within the scope of the invention. For example, although specific interfaces, external display configurations, and protocols have been described, other types of interfaces, configurations or types of displays, and/or protocols, can be accommodated in accordance with embodiments of the present invention. Also, applications other than portable computing devices or the like can also be accommodated in accordance with particular embodiments. Embodiments of the invention can also operate among any one or more processes or entities including users, devices, functional systems, and/or combinations of hardware and software.

Any suitable programming language can be used to implement the functionality of the present invention including C, C++, Java, assembly language, etc. Different programming techniques can be employed such as procedural or object oriented. The routines can execute on a single processing device or multiple processors. Although the steps, operations or computations may be presented in a specific order, this order may be changed in different embodiments unless otherwise specified. In some embodiments, multiple steps shown as sequential in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing. The functions may be performed in hardware, software or a combination of both.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “computer-readable medium” for purposes of embodiments of the present invention may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. Functions and parts of functions described herein can be achieved by devices in different places and operating at different times. For example, a processor can perform its functions in “real time,” “offline,” in a “batch mode,” etc. Parallel, distributed or other processing approaches can be used.

Reference throughout this specification to “one embodiment”, “an embodiment”, “a particular embodiment,” or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of the present invention can be achieved by any means as is known in the art. For example, distributed, networked systems, components and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

Thus, the scope of the invention is to be determined solely by the appended claims.

1. A method, comprising:
using an interface of a portable computing device to define preferred settings, wherein the preferred settings designate preferences for a display that is external to the portable computing device;
detecting in the portable computing device, a connection of an external display to the portable computing device;
loading the preferred settings when capabilities of the external display support the preferred settings; and
adjusting settings of the external display to match the preferred settings.

2. The method of claim 1, further comprising temporarily adjusting the preferred settings during the connection to match the capabilities of the external display when the external display does not fully support the preferred settings.

3. The method of claim 2, further comprising reading the display capabilities using a display data channel (DDC) between the external display and the portable computing device.

4. The method of claim 2, wherein the adjusting the preferred settings comprises applying a predetermined weighting for each of the preferred settings.

5. The method of claim 1, wherein the using the interface of the portable computing device comprises selecting a refresh rate as one of the preferred settings.

6. The method of claim 1, wherein the using the interface of the portable computing device comprises selecting a color depth as one of the preferred settings.

7. The method of claim 1, wherein the using the interface of the portable computing device comprises selecting a resolution as one of the preferred settings.

8. The method of claim 1, wherein the using the interface of the portable computing device comprises selecting a font hinting as one of the preferred settings.

9. The method of claim 1, wherein the detecting the connection comprises using a video graphics array (VGA) connector.

10. The method of claim 1, wherein the loading the preferred settings comprises retrieving the preferred settings from a store in the portable computing device.

11. A portable computing device, comprising:
one or more processors; and
logic encoded in one or more tangible media for execution by the one or more processors, and when executed operable to:
use an interface of a portable computing device to define preferred settings, wherein the preferred settings designate preferences for a display that is external to the portable computing device;
detect in the portable computing device, a connection of an external display to the portable computing device;
load the preferred settings when capabilities of the external display support the preferred settings; and
adjust settings of the external display to match the preferred settings.

12. The portable computing device of claim 11, wherein the one or more processors comprise an embedded controller.

13. The portable computing device of claim 11, wherein the logic when executed is further operable to temporarily adjust the preferred settings during the connection to match the capabilities of the external display when the external display does not fully support the preferred settings.

14. The portable computing device of claim 13, wherein a display data channel (DDC) between the external display and the portable computing device is used to read of the capabilities of the external display.

15. The portable computing device of claim 13, wherein a predetermined weight for each of the preferred settings is used for the temporary adjustment of the preferred settings.

16. The portable computing device of claim 11, wherein the interface of the portable computing device for the preferred settings comprises selections of a refresh rate, a color depth, a resolution, and a font hinting.

17. The portable computing device of claim 11, wherein a video graphics array (VGA) connector is used for detection of the connection.

18. The portable computing device of claim 11, further comprising a store for the preferred settings.

19. An apparatus, comprising:
means for using an interface of a portable computing device to define preferred settings, wherein the preferred settings designate preferences for a display that is external to the portable computing device;
means for detecting in the portable computing device, a connection of an external display to the portable computing device;
means for loading the preferred settings when capabilities of the external display support the preferred settings; and
means for adjusting settings of the external display to match the preferred settings.

20. The apparatus of claim 19, further comprising means for temporarily adjusting the preferred settings during the connection to match the capabilities of the external display when the external display does not fully support the preferred settings.
